(19) United States
(12) Patent Application Publication
(10) Pub. No.: US 2024/0329608 A1
(43) Pub. Date: Oct. 3, 2024

(54) A Method, Device, System and Storage Medium for Scheme Recommendation

(71) Applicant: Siemens Aktiengesellschaft, München (DE)

(72) Inventors: Bin Zhang, Beijing (CN); Armin Roux, Höchstadt a. d. Aisch (DE); Peng Zhang, Beijing (CN); Shunjie Fan, Beijing (CN)

(73) Assignee: Siemens Aktiengesellschaft, München (DE)

(21) Appl. No.: 18/574,470

(22) PCT Filed: Jun. 29, 2021
(86) PCT No.: PCT/CN2021/103248

§ 371 Date: Dec. 27, 2023

(51) Int. Cl. G05B 13/02; G06F 16/2457

(52) U.S. Cl. CPC G05B 13/027; G06F 16/24578

(57) ABSTRACT

Various embodiments of the teachings herein include a method for scheme recommendation. An example includes: obtaining a technical request for a factory production, with a candidate and job recommendation request for a production task, a technical scheme request for a type of work and specific requirement, or a technical expert and solution request for a technical problem; performing analysis and feature extraction on the request and obtaining corresponding current request description information; according to the information, adopting a neural network algorithm for deep learning using historical searching cases in a case database to obtain a searching algorithm from multiple algorithms using case-based reasoning; and obtaining corresponding recommendation scheme after an information database established with industrial technology information, technical characteristics information of workers, and technical expertise information of engineering experts is searched by the at least one searching algorithm.

### CROSS-REFERENCE TO RELATED APPLICATIONS

This application is a U.S. National Stage Application of International Application No. PCT/CN2021/103248 filed Jun. 29, 2021, which designates the United States of America, the contents of which are hereby incorporated by reference in their entirety.

### TECHNICAL FIELD

The present disclosure relates to digital factory technologies. Various embodiments of the teachings herein include methods, devices, systems, and computer readable storage medium for scheme recommendation.

### BACKGROUND

Digital technology refers to a technology with which computers and networks are used to achieve digital. Digital technology has been applied to a variety of industries and fields, such as traditional manufacturing plants. Digital factories provide digital and information services for traditional manufacturing plants by using computer hardware and software technology. A digital factory integrates various systems and databases of factory, product and control, and improves the flexibility and efficiency of factory manufacturing process by means of visualization, simulation and big data.

In the actual production of a current factory, there are a large number of complex production tasks and production indicators. For different production tasks, there are usually different candidates and jobs recommendation schemes; for different work types and specific requirements, there are usually different technical implementation schemes; for different technical problems, there are usually different solutions. However, these operations cannot be realized in the current digital factory, so it is necessary to establish an intelligent expert recommendation system for the optimal scheme of various technical requests.

### SUMMARY

Some examples of the teachings of the present disclosure include methods, devices, systems, and computer readable storage medium for scheme recommendation to achieve the intelligent optimal scheme recommendation for a technical request in the digital factory. For example, some embodiments include a method for scheme recommendation comprising: obtaining a technical request for a factory production, wherein the technical request is a candidate and job recommendation request for a production task, a technical scheme request for a type of work and specific requirement, or a technical expert and solution request for a technical problem; performing analysis and feature extraction on the technical request, and obtaining corresponding current request description information; according to the current request description information, adopting a neural network algorithm for deep learning by using historical searching cases in a case database to obtain at least one searching algorithm from multiple searching algorithms based on case-based reasoning; and obtaining corresponding recommendation scheme after an information database established with industrial technology information, technical characteristics information of workers and technical expertise information of engineering experts is searched by the at least one searching algorithm.

In some embodiments, the method further includes: when the at least one searching algorithm is two or more searching algorithms, sorting and integrating searched items in the recommendation scheme obtained by at least one searching algorithm according to the coincidence rate and weight of each searched item in each recommendation scheme, and obtaining the integrated recommendation scheme.

In some embodiments, the method further includes: when the at least one searching algorithm is one searching algorithm, determining the one searching algorithm as a preferred searching algorithm; when the at least one retrieval algorithm is two or more searching algorithms, performing a similarity matching between the integrated recommendation scheme and recommendation scheme obtained by each of the at least one searching algorithm, and at least one searching algorithm with the highest matching degree or at least one searching algorithm with the matching degree reaching a set threshold is regarded as preferred searching algorithm; and storing the current request description information and at least one preferred searching algorithm as a searching case in the case database.

In some embodiments, before storing the current request description information and at least one preferred searching algorithm as a searching cases in the case database, the method further includes: providing the recommendation scheme obtained by each of the at least one preferred searching algorithm to a user for result scoring; after obtaining a corresponding result score, storing the current request description information and each of at least one preferred searching algorithm and a result score thereof in the case database as a searching case.

In some embodiments, wherein the multiple searching algorithms includes at least one or more of self-organizing maps algorithm, singular value decomposition algorithm, K-means clustering algorithm, and a priori algorithm for mining association rules.

In some embodiments, the method further includes: storing the technical request, the current request description information and corresponding recommendation scheme as a recommendation case in a result database, so as to obtain the corresponding recommendation scheme by searching the result database according to a technical request or a request description information in offline mode.

In some embodiments, performing analysis and feature extraction on the technical request includes: for a technical request in the form of structured information or structured information in a technical request, using a semantic analysis module to perform analysis and feature extraction on the structural information based on pre-determined analytical rules; for a technical request in the form of unstructured information or unstructured information in a technical request, adopting an information analysis model to perform analysis and feature extraction on the unstructured information; the information analysis model is trained by taking a large number of historical unstructured information as input samples and corresponding historical request description information as output samples.

As another example, some embodiments include a device for scheme recommendation comprising: a data obtaining module to obtain a technical request for a factory production; wherein the technical request is: a candidate and job recommendation request for a production task, a technical scheme request for a type of work and specific requirement, or a technical expert and solution request for a technical problem; an analysis module to perform analysis and feature extraction on the technical request to obtain corresponding current request description information; an algorithm matching module to obtain at least one searching algorithm from a plurality of searching algorithms based on case-based reasoning by adopting a neural network algorithm for deep learning using historical searching cases in a case database according to the current request description information; and a scheme recommendation to module obtain corresponding recommendation scheme after an information database established with industrial technology information, technical characteristics information of workers and technical expertise information of engineering experts is searched by the at least one searching algorithm.

In some embodiments, the device further includes a scheme integration module, configured to, when the at least one searching algorithm is two or more searching algorithms, sort and integrate the searched items in the recommendation schemes obtained by the at least one searching algorithm according to the coincidence rate and weight of each searched item in each recommendation scheme to obtain an integrated recommendation scheme.

In some embodiments, the device further includes a case determination module to determine one searching algorithm as a preferred searching algorithm when the at least one of the searching algorithms is the one searching algorithms; to match the integrated recommendation scheme with recommendation scheme obtained by each of the at least one searching algorithm respectively when the at least one searching algorithm is two or more searching algorithms, and at least one searching algorithm with the highest matching degree or at least one searching algorithm with a matching degree reaching a set threshold is determined as preferred searching algorithm; to store the current request description information and at least one preferred searching algorithm in the case database as a searching case.

In some embodiments, the case determination module further provides the recommendation scheme obtained by the at least one preferred searching algorithm to a user for result scoring before storing the current request description information and at least one preferred searching algorithm as a searching case in the case database; after obtaining a corresponding result score, store the current request description information, each of the at least one preferred searching algorithm and a result score thereof in the case database as a searching case.

In some embodiments, the device further includes an offline recommendation module, to store the technical request, the current request description information and corresponding recommendation scheme in a result database as a recommendation case, and in offline mode, according to a received technical request or a request description information, to obtain the corresponding recommendation scheme by searching the result database.

As another example, some embodiments include a device for scheme recommendation comprising: at least one memory to store a computer program; and at least one processor to call the computer program stored in the at least one memory to perform one or more of the methods for scheme recommendation described herein.

As another example, some embodiments include a system for scheme recommendation comprising: a device for scheme recommendation as described herein; a case database to store historical searching cases, each of which includes historical request description information and adopted searching algorithm; an information database to store industrial technical information, technical characteristics information of workers and technical expertise information of engineering experts; and a results database to store recommendation cases, each of which includes historical technical request, historical request description information and corresponding recommendation scheme.

As another example, some embodiments include a non-transitory computer-readable storage medium, on which a computer program is stored, the computer program to be executed by one or more processors to implement one or more of the methods for scheme recommendation described herein.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures. In the drawings:

FIG. 1 is a flow diagram illustrating a method for scheme recommendation incorporating teachings of the present disclosure;

FIG. 2 is a schematic diagram illustrating an association relationship for technical characteristic information of workers in the information database incorporating teachings of the present disclosure;

FIG. 3 is a schematic diagram illustrating a device for scheme recommendation incorporating teachings of the present disclosure;

FIG. 4 is a schematic diagram illustrating another device for scheme recommendation incorporating teachings of the present disclosure; and

FIG. 5 is a schematic diagram illustrating a system for scheme recommendation incorporating teachings of the present disclosure.

The reference numerals are as follows:

| Reference numeral | Object |
|---|---|
| 101~104 | processes |
| 21 | workpiece |
| 221, 222, 223, . . . , 22M | craft workshop |
| 231, 232, 233, 234, . . . , 23N | worker |
| 31 | data obtaining module |
| 32 | analysis module |
| 33 | algorithm matching module |
| 34 | scheme recommendation module |
| 35 | scheme integration module |
| 36 | case determination module |
| 37 | offline recommendation module |
| 41 | memory |
| 42 | processor |
| 43 | bus |
| 51 | device for scheme |
| | recommendation |
| 52 | case database |
| 53 | information database |
| 54 | result database |

### DETAILED DESCRIPTION

It can be seen from the above mentioned technical solutions in embodiments of the present disclosure, because the information database about industrial technology information, technical characteristics information of workers and technical expertise information of engineering experts is established, and a variety of searching algorithms are set for different technical requests, and the appropriate search algorithm is selected for each search to search the recommended scheme. Therefore, the optimal scheme recommendation for each specific technical request in digital factory is achieved.

In addition, users can submit technical requests in a variety of structured or unstructured ways, so the operation of the user terminal is simplified, the requirements for the user terminal are reduced, and flexibility and the efficiency of scheme recommendation are improved. Furthermore, the accuracy of algorithm recommendation can be improved with the passage of time by continuously adding new searching cases for reference in the selection of searching algorithm. In addition, by continuously adding new recommendation cases, scheme recommendation can be implemented offline, which further improves the flexibility and efficiency of scheme recommendation.

In various embodiments of the present disclosure, in order to meet the scheme recommendation for various technical requests in the digital factory, for example, the candidate and job recommendation for a production task, the technical scheme recommendation for a type of work in production and requirements, or the technical experts and solutions recommendation for a technical problem, etc., an information database on industrial technical information, technical characteristics information of workers and technical expertise information of engineering experts can be established. Considering that different searching algorithms may be used for different types of searching in large databases, in order to meet the searching of various technical requests, a variety of searching algorithms are set up, and the appropriate retrieval algorithm is selected for each searching. Furthermore, new searching cases can be added continuously for reference in the selection of searching algorithm. In addition, new recommendation cases can be added to make scheme recommendation offline.

Reference will now be made in detail to examples, which are illustrated in the accompanying drawings. In the following detailed description, numerous specific details are set forth in order to provide a thorough understanding of the present disclosure. Also, the figures are illustrations of an example, in which modules or procedures shown in the figures are not necessarily essential for implementing the present disclosure. In other instances, well-known methods, procedures, components, and circuits have not been described in detail so as not to unnecessarily obscure aspects of the examples.

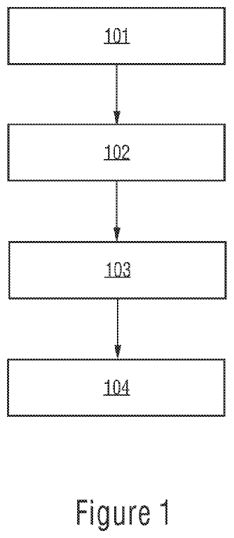

FIG. 1 is a flow diagram illustrating a method for scheme recommendation incorporating teachings of the present disclosure. As shown in FIG. 1, the method may include the following processes.

At block 101, a technical request for a factory production is obtained. The technical request may include: a candidate and job recommendation request for a production task, a technical scheme request for a type of work and specific requirement, or a technical expert and solution request for a technical problem, etc. The technical request can be put forward in various ways. For example, the technical request can be submitted in the form of structured information, such as Word, Excel and other text files. It can also be submitted in the form of unstructured information, such as audio, video, pictures and other multimedia content. In addition, the technical request can also be submitted in the form of structured information and unstructured information. The technical request may be obtained by a data collection module of a robot, such as a knowledge transfer robot.

At block 102, analysis and feature extraction is performed on the technical request, and the corresponding current request description information is obtained. In this specific implementation, for the technical request in the form of structured information or for structural information in the technical request, a semantic analysis module may be used to perform analysis and feature extraction on the structural information based on pre-determined analytical rules to obtain the request description information including a category, an attribute, and at least one searching keyword corresponding to the technical request. For the technical request in the form of unstructured information or for unstructured information in the technical request, an information analysis model may be used to perform analysis and feature extraction on the unstructured information to obtain the request description information of the category, attribute and at least one searching keyword corresponding to the technical request. In addition, in view of the situation that technical requests are submitted in the form of structured information and unstructured information, the results obtained by the semantic analysis module and the results obtained by the information analysis model can be integrated to get the unified request description information.

The information analysis model can be trained by taking a large number of historical unstructured information such as multimedia content as input samples and taking the corresponding historical request description information or historical description characteristics as the output samples. In one example, the information analysis model can include a classification model and multiple information analysis sub models. The classification model is used to classify unstructured information such as multimedia content and provide unstructured information into corresponding information analysis sub model according to classification results. Each information analysis sub model is used to generate the corresponding request description information according to the input unstructured information such as multimedia content.

Furthermore, the semantic analysis module and the information analysis model may further the feed request description information back to the user for viewing and receive the request description information confirmed by the user. When the request description information fed back by the semantic analysis module and/or the information analysis model is consistent with the actual problem, the user can confirm directly, and the request description information confirmed by the user is consistent with the request description information fed back by the semantic analysis module or the information analysis model. When the request description information fed back by the semantic analysis module or the information analysis model is inconsistent with the actual problem, the user can manually write new request description information or modify the feedback request description information, and the request description information confirmed by the user is the user's new or modified request description information. Then, the request description information confirmed by the user is regarded as the final current request description information, that is, the correct request description information.

The correct request description information and corresponding multimedia content can be used as a new historical sample to optimize the information analysis model. When there is a sample database, the correct request description information and corresponding unstructured content such as multimedia content can be stored in the sample database as a new record item, and then the information analysis model can be optimized according to the updated sample database. The sample database can be a cloud sample database. Because the unstructured content and request description information in cloud sample database is huge, the information analysis model can be trained and updated in time, so the accuracy of the information analysis model will be very high.

At block 103, according to the current request description information, a neural network algorithm for deep learning by using historical searching cases in a case database is adopted to obtain at least one searching algorithm from a plurality of searching algorithms based on case-based reasoning. In this embodiment, multiple retrieval algorithms may include at least one or more of self-organizing maps (SOM) algorithm, singular value decomposition (SVD) algorithm, K-means clustering (Kmeans) algorithm and Aprior algorithm for mining association rules, other existing or future algorithms can also be included. Historical searching cases may include searching cases composed of historical request description information and its corresponding searching algorithm, or searching cases composed of historical request description information and its corresponding searching algorithm and result score, etc.

The neural network algorithm for deep learning based on historical searching cases in case database may be a LSTM (long short term memory) algorithm. Based on a LSTM algorithm, it can record all kinds of problems in factory production, including searching cases corresponding to all kinds of technical requests. In this way, the system continuously reads and stores new searching cases. Through machine learning, the accuracy of algorithm recommendation may be continuously improved with the increase of usage time, the waste and occupation of computing resources may be greatly reduced, and the accuracy and efficiency of learning may be improved. Based on case-based reasoning method, according to the characteristics of each searching algorithm and the historical records used before, the appropriate searching algorithm will be reasonably matched every time the searching is executed, and the searching algorithm that does not conform to the request description information will be eliminated, which can reduce the number of searching algorithms used in the background at the same time.

At block 104, the corresponding recommendation scheme is obtained after an information database established with industrial technology information, technical characteristics information of workers and technical expertise information of engineering experts is searched by the at least one searching algorithm. In this embodiment, the information in the information database can have complex association relations and can be stored in a variety of structural forms. For example, it can be stored in the form of knowledge map, data chart and blockchain.

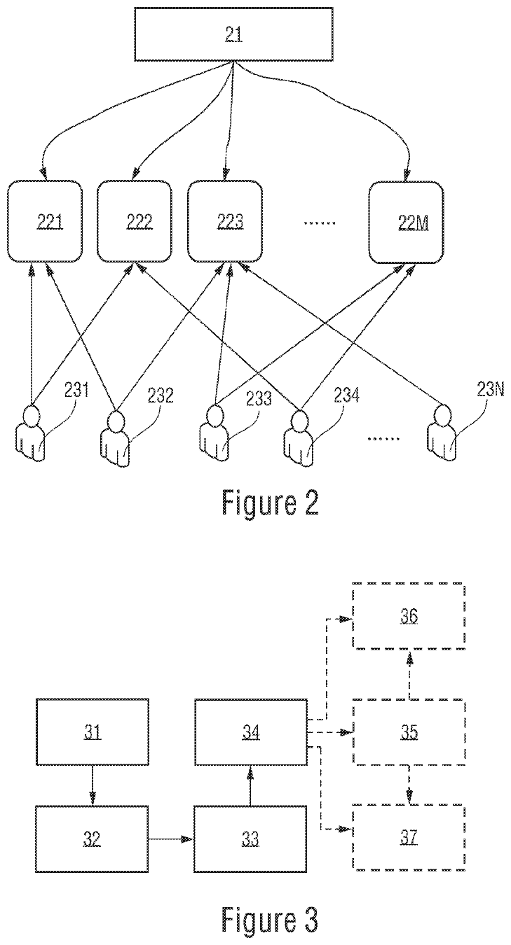

FIG. 2 is a schematic diagram illustrating an association relationship for technical characteristic information of workers in the information database incorporating teachings of the present disclosure. As shown in FIG. 2, the processing of a specific workpiece 21 can be completed in M different craft workshops 221, 222, 223 . . . 22M respectively, and by N different workers 231, 232, 233, 234 . . . 23N with different proficiencies in different craft workshops.

For example, the worker 231 can process the workpiece 21 with 0.8 proficiency in the craft workshop 221, but can only process the workpiece 21 with 0.6 proficiency in the craft workshop 222; worker 232 can process workpiece 21 with 0.7 proficiency in craft workshop 221, but can process workpiece 21 with 0.9 proficiency in craft workshop 223; worker 233 can process the workpiece 21 with 0.6 proficiency in craft workshop 223, but can process the workpiece 21 with 0.9 proficiency in craft workshop 22M; worker 234 can process the workpiece 21 with 0.8 proficiency in craft workshop 222, but can only process the workpiece 21 with 0.7 proficiency in craft workshop 22m; worker 23N can only process the workpiece 21 with 0.5 proficiency in craft workshop 223. Therefore, when processing the workpiece 21, the final recommended scheme may include: recommend worker 232 to process the workpiece 21 in craft workshop 223, or recommend worker 233 to process the workpiece 21 in craft workshop 22m . . . . In addition, the current working status of the workers can be further obtained. If the worker is currently busy, the recommendation scheme can exclude the busy worker.

In this embodiment, the recommendation scheme obtained by at least one searching algorithm can be directly provided as the final recommendation scheme to the user submitting the technical request. Alternatively, when the at least one searching algorithm is two or more searching algorithms, the recommendation schemes obtained by each searching algorithm can be integrated, and the integrated recommendation scheme can be provided as the final recommendation scheme to the user who submits the technical request. In some embodiments, searched items in the recommendation scheme obtained by at least one searching algorithm can be sorted and integrated to obtain the integrated recommendation scheme according to the coincidence rate and weight of each searched item in each recommendation scheme.

In addition, when the at least one searching algorithm is one searching algorithm, the one searching algorithm may be directly used as the preferred searching algorithm corresponding to the current request description information. When the at least one searching algorithm is two or more searching algorithms, the integrated recommendation scheme is matched with recommendation scheme obtained by each of the at least one searching algorithm respectively, and at least one searching algorithm with the highest matching degree or at least one searching algorithm with the matching degree reaching a set threshold is regarded as the preferred searching algorithm.

After determining the preferred searching algorithm, the current request description information and the corresponding preferred searching algorithm may be stored in the case database as a searching case. In some embodiments, the current request description information may be further compared with the same type of historical request description information obtained from the case database based on the collaborative filtering algorithm. When there is a difference between the current request description information and the same type of historical request description information, the current request description information and at least one preferred searching algorithm are stored in the case database as a searching case.

In addition, the recommendation scheme obtained by each preferred searching algorithm can be provided to the user for result effectiveness scoring. After the corresponding result score is obtained, the current request description information and the corresponding preferred searching algorithm and the result score can be stored in the case database as a searching case.

Furthermore, the current technical request, the current request description information and the final recommendation scheme can be stored in a result database as a result case, so that the corresponding recommendation scheme can be obtained by searching the result database according to a technical request or request description information in offline mode.

FIG. 3 is a schematic diagram illustrating a device for scheme recommendation incorporating teachings of the present disclosure. The device may be used to perform the method shown in FIG. 1. For the contents not disclosed in detail in the device embodiments of the present disclosure, please refer to the corresponding description in the method embodiments of the present disclosure, and will not be repeated hereinafter. As shown in the solid line part in FIG. 3, the device may include a data obtaining module 31, an analysis module 32, an algorithm matching module 33 and a scheme recommendation module 34.

The data obtaining module 31 is configured to obtain a technical request for the factory production. The technical request may be: a candidate and job recommendation request for a production task, a technical scheme request for a type of work and specific requirement, or a technical expert and solution request for a technical problem, etc.

The analysis module 32 is configured to perform analysis and feature extraction on the technical request to obtain the corresponding current request description information. Specifically, for the technical request in the form of structured information or the structured information in the technical request, a semantic analysis module may be used to perform analysis and feature extraction on the structural information based on pre-determined analytical rules to obtain the request description information. For the technical request in the form of unstructured information or the unstructured information in the technical request, an information analysis model may be adopted to perform analysis and feature extraction on the unstructured information. The information analysis model may be trained by taking a large number of historical unstructured information as input samples and its corresponding historical request description information as output samples. In the embodiment of the present application, the request description information may include a category, an attribute and at least one searching keyword corresponding to the technical request.

The algorithm matching module 33 is configured to obtain at least one searching algorithm from a plurality of searching algorithms based on case-based reasoning by adopting a neural network algorithm for deep learning using historical searching cases in a case database according to the current request description information.

The scheme recommendation module 34 is configured to obtain corresponding recommendation scheme after an information database established with industrial technology information, technical characteristics information of workers and technical expertise information of engineering experts is searched by the at least one searching algorithm.

In some embodiments, as shown in the dotted line part in FIG. 3, the device may further include a scheme integration module 35 which is configured to, when the at least one searching algorithm is two or more searching algorithms, sort and integrate the searched items in the recommendation schemes obtained by the at least one searching algorithm according to the coincidence rate and weight of each searched item in each recommendation scheme to obtain an integrated recommendation scheme.

In some embodiments, as shown in the dotted line part of FIG. 3, the device may also further include a case determination module 36 configured to determine one searching algorithm as a preferred searching algorithm when the at least one of the searching algorithms is the one searching algorithms, to match the integrated recommendation scheme with the recommendation scheme obtained by each of the at least one searching algorithm respectively when the at least one searching algorithm is two or more searching algorithms, and at least one searching algorithm with the highest matching degree or at least one searching algorithm with the matching degree reaching a set threshold is determined as the preferred searching algorithm, and to store the current request description information and at least one preferred searching algorithm in the case database as a searching case.

In some embodiments, the case determination module 36 may provide the recommendation scheme obtained by the at least one preferred searching algorithm to a user for result scoring before storing the current request description information and at least one preferred searching algorithm as a searching case in the case database; after obtaining a corresponding result score, store the current request description information, each of the at least one preferred searching algorithm and a result score thereof in the case database as a searching case.

In some embodiments, as shown in the dotted line in FIG. 3, the device may further include an offline recommendation module 37 configured to store the technical request, the current request description information, and the corresponding recommendation scheme in a result database as a recommendation case, and in offline mode, according to a received technical request or a request description information, to obtain the corresponding recommendation scheme by searching the result database. In fact, the device for scheme recommendation provided by this implementation manner of the present disclosure may be specifically implemented in various manners. For example, the device for scheme recommendation may be compiled, by using an application programming interface that complies with a certain regulation, as a plug-in that is installed in an intelligent terminal, or may be encapsulated into an application program for a user to download and use.

When compiled as a plug-in, the device for scheme recommendation may be implemented in various plug-in forms such as ocx, dll, and cab. The device for scheme recommendation provided by this implementation may also be implemented by using a specific technology, such as a Flash plug-in technology, a RealPlayer plug-in technology, an MMS plug-in technology, a MIDI staff plug-in technology, or an ActiveX plug-in technology.

The method for scheme recommendation provided by this implementation may be stored in various storage mediums in an instruction storage manner or an instruction set storage manner. These storage mediums include, but are not limited to: a floppy disk, an optical disc, a DVD, a hard disk, a flash memory, a USB flash drive, a CF card, an SD card, an MMC card, an SM card, a memory stick, and an xD card.

In addition, the method for scheme recommendation provided by this implementation may also be applied to a storage medium based on a flash memory (Nand flash), such as USB flash drive, a CF card, an SD card, an SDHC card, an MMC card, an SM card, a memory stick, and an xD card.

Moreover, it should be clear that an operating system operated in a computer can be made, not only by executing program code read by the computer from a storage medium, but also by using an instruction based on the program code, to implement some or all actual operations, so as to implement functions of any embodiment in the foregoing embodiments.

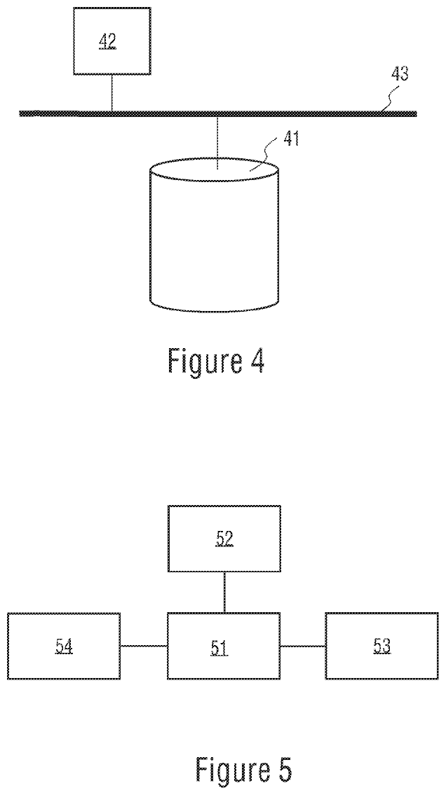

For example, FIG. 4 is a schematic diagram illustrating another device for scheme recommendation incorporating teachings of the present disclosure. The device may be used to perform the method shown in FIG. 1, or to implement the device shown in FIG. 3. As shown in FIG. 4, the device may include at least one memory 41 and at least one processor 42. In addition, some other components may be included, such as communication port, input/output controller, network communication interface, etc.

These components communicate through bus 43, etc.

At least one memory 41 is configured to store a computer program. In one example, the computer program can be understood to include various modules of the device shown in FIG. 3. In addition, at least one memory 41 may store an operating system or the like. Operating systems include but are not limited to: Android operating system, Symbian operating system, windows operating system, Linux operating system, etc.

At least one processor 42 is configured to call the computer program stored in at least one memory 41 to perform a method for scheme recommendation described in examples of the present disclosure. The processor 42 can be CPU, processing unit/module, ASIC, logic module or programmable gate array, etc. It can receive and send data through the communication port.

The I/O controller has a display and an input device, which is used to input, output and display relevant data.

Some embodiments include a system for scheme recommendation. The system may include the device for scheme recommendation shown in FIG. 3. In addition, the system may further include a case database 52, an information database 53, and a result database 54.

The case database 52 is configured to store historical searching cases, each of which includes historical request description information and adopted searching algorithm.

The information database 53 is configured to store industrial technical information, technical characteristics information of workers and technical expertise information of engineering experts.

The results database 54 is configured to store recommendation cases, each of which includes historical technical request, historical request description information and corresponding recommendation scheme.

Further, the system may further include a sample database (not shown in FIG. 5) which is configured to store samples consisting of technical requests in the form of unstructured information and corresponding request description information.

It can be seen from above mentioned technical solutions in embodiments of the present disclosure, because the information database about industrial technology information, technical characteristics information of workers and technical expertise information of engineering experts is established, and a variety of searching algorithms are set for different technical requests, and the appropriate search algorithm is selected for each search to search the recommended scheme. Therefore, the optimal scheme recommendation for each specific technical request in digital factory is achieved.

In addition, users can submit technical requests in a variety of structured or unstructured ways, so the operation of the user terminal is simplified, the requirements for the user terminal are reduced, and the flexibility and efficiency of scheme recommendation are improved. Furthermore, the accuracy of algorithm recommendation can be further improved with the passage of time by continuously adding new searching cases for reference in the selection of searching algorithm. In addition, by continuously adding new recommendation cases, scheme recommendation can be implemented offline, which further improves the flexibility and efficiency of scheme recommendation.

It should be understood that, as used herein, unless the context clearly supports exceptions, the singular forms “a” (“a”, “an”, “the”) are intended to include the plural forms. It should also be understood that, “and/or” used herein is intended to include any and all possible combinations of one or more of the associated listed items. The number of the embodiments of the present disclosure are only used for description, and do not represent the merits of the implementations.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

What is claimed is:

1. A method for scheme recommendation, the method comprising:
obtaining a technical request for a factory production, wherein the technical request comprises a candidate and job recommendation request for a production task, a technical scheme request for a type of work and specific requirement, or a technical expert and solution request for a technical problem;
performing analysis and feature extraction on the technical request and obtaining corresponding current request description information;
according to the current request description information, adopting a neural network algorithm for deep learning by using historical searching cases in a case database to obtain at least one searching algorithm from multiple searching algorithms based on case-based reasoning; and
obtaining corresponding recommendation scheme after an information database established with industrial technology information, technical characteristics information of workers, and technical expertise information of engineering experts is searched by the at least one searching algorithm.

2. The method according to claim 1, further comprising, when the at least one searching algorithm is two or more searching algorithms, sorting and integrating searched items in the recommendation scheme obtained by at least one searching algorithm according to the coincidence rate and weight of each searched item in each recommendation scheme, and obtaining the integrated recommendation scheme.

3. The method according to claim 2, further comprising:
when the at least one searching algorithm is one searching algorithm, determining the one searching algorithm as a preferred searching algorithm;
when the at least one retrieval algorithm is two or more searching algorithms, performing a similarity matching between the integrated recommendation scheme and recommendation scheme obtained by each of the at least one searching algorithm, and at least one searching algorithm with the highest matching degree or at least one searching algorithm with the matching degree reaching a set threshold is regarded as preferred searching algorithm; and
storing the current request description information and at least one preferred searching algorithm as a searching case in the case database.

4. The method according to claim 3, further comprising:
before storing the current request description information and at least one preferred searching algorithm as a searching cases in the case database, providing the recommendation scheme obtained by each of the at least one preferred searching algorithm to a user for result scoring; and
after obtaining a corresponding result score, storing the current request description information and each of at least one preferred searching algorithm and a result score thereof in the case database as a searching case.

5. The method according to claim 1, wherein the multiple searching algorithms each comprise: at least one or more of self-organizing maps algorithm, singular value decomposition algorithm, K-means clustering algorithm, and a prior algorithm for mining association rules.

6. The method according to claim 1, further comprising storing the technical request, the current request description information and corresponding recommendation scheme as a recommendation case in a result database, so as to obtain the corresponding recommendation scheme by searching the result database according to a technical request or a request description information in offline mode.

7. The method according to claim 1, wherein performing analysis and feature extraction on the technical request comprises:
for a technical request in the form of structured information or structured information in a technical request, using a semantic analysis module to perform analysis and feature extraction on the structural information based on pre-determined analytical rules; and
for a technical request in the form of unstructured information or unstructured information in a technical request, adopting an information analysis model to perform analysis and feature extraction on the unstructured information;
wherein the information analysis model is trained by taking a large number of historical unstructured information as input samples and corresponding historical request description information as output samples.

8. A device for scheme recommendation, the device comprising:
a data obtaining module, to obtain a technical request for a factory production, wherein the technical request includes: a candidate and job recommendation request for a production task, a technical scheme request for a type of work and specific requirement, or a technical expert and solution request for a technical problem;
an analysis module, to perform analysis and feature extraction on the technical request to obtain corresponding current request description information;
an algorithm matching module, to obtain at least one searching algorithm from a plurality of searching algorithms based on case-based reasoning by adopting a neural network algorithm for deep learning using historical searching cases in a case database according to the current request description information; and
a scheme recommendation module, to obtain corresponding recommendation scheme after an information database established with industrial technology information, technical characteristics information of workers, and technical expertise information of engineering experts is searched by the at least one searching algorithm.

9. The device according to claim 8, further comprising a scheme integration module, configured to, when the at least one searching algorithm is two or more searching algorithms, sort and integrate the searched items in the recommendation schemes obtained by the at least one searching algorithm according to the coincidence rate and weight of each searched item in each recommendation scheme to obtain an integrated recommendation scheme.

10. The device according to claim 9, further comprising a case determination module:
to determine one searching algorithm as a preferred searching algorithm when the at least one of the searching algorithms is the one searching algorithms;
to match the integrated recommendation scheme with recommendation scheme obtained by each of the at least one searching algorithm respectively when the at least one searching algorithm is two or more searching algorithms, and at least one searching algorithm with the highest matching degree or at least one searching algorithm with a matching degree reaching a set threshold is determined as preferred searching algorithm; and
to store the current request description information and at least one preferred searching algorithm in the case database as a searching case.

11. The device according to claim 10, wherein the case determination module further provides the recommendation scheme obtained by the at least one preferred searching algorithm to a user for result scoring before storing the current request description information and at least one preferred searching algorithm as a searching case in the case database; after obtaining a corresponding result score, store the current request description information, each of the at least one preferred searching algorithm and a result score thereof in the case database as a searching case.

12. The device according to claim 8, further comprising an offline recommendation module to store the technical request, the current request description information and corresponding recommendation scheme in a result database as a recommendation case, and in offline mode, according to a received technical request or a request description information, to obtain the corresponding recommendation scheme by searching the result database.

13. (canceled)

14. A system for scheme recommendation, the system comprising:
a data obtaining module to obtain a technical request for a factory production, wherein the technical request includes: a candidate and job recommendation request for a production task, a technical scheme request for a type of work and specific requirement, or a technical expert and solution request for a technical problem;
an analysis module to perform analysis and feature extraction on the technical request to obtain corresponding current request description information;
an algorithm matching module to obtain at least one searching algorithm from a plurality of searching algorithms based on case-based reasoning by adopting a neural network algorithm for deep learning using historical searching cases in a case database according to the current request description information; and
a scheme recommendation module to obtain corresponding recommendation scheme after an in information database established with industrial technology information, technical characteristics information of workers, and technical expertise information of engineering experts is searched by the at least one searching algorithm;
a case database, to store historical searching cases, each of which includes historical request description information and adopted searching algorithm;
an information database, to store industrial technical information, technical characteristics information of workers and technical expertise information of engineering experts; and
a results database, to store recommendation cases, each of which includes historical technical request, historical request description information and corresponding recommendation scheme.

15. (canceled)
